(19) United States
(12) Patent Application Publication
(10) Pub. No.: US 2009/0011211 A1
(43) Pub. Date: Jan. 8, 2009

(54) Metal matrix composite bodies, and methods for making same

(76) Inventors: Jerry Weinstein, Malta, NY (US); Jai R. Singh, Shelton, CT (US); Michael K. Aghajanian, Newark, DE (US); Eric M. Klier, Hockessin, DE (US)

Correspondence Address: Jeffrey R. Ramberg;Law Office of Jeffrey R. Ramberg, 18 Old Manor Road, Newark, DE, 19711-8013, US

(21) Appl. No.: 12/074,703

(22) Filed: Mar. 5, 2008

Related U.S. Application Data
(63) Continuation-in-part of application No. PCT/US06/35001, filed on Sep. 7, 2006.
(60) Provisional application No. 60/715,101, filed on Sep. 7, 2005.

(51) Int. Cl. B32B 5/00; B22D 23/00

(52) U.S. Cl. 428/220; 164/48

(57) ABSTRACT

A metal matrix composite (MMC) material that is castable, or can be rendered castable, is melted and cast into a mold or crucible, and at least a portion of the plurality of reinforcement bodies is permitted to at least partially settle out of their suspension in the molten matrix metal. The casting is solidified, and the sparsely loaded supernatant is separated from the zone of the casting containing the sediment—either by cutting, sawing, etc., or by decanting the supernatant when the casting was still in a molten condition. In a preferred embodiment, during the settling and/or the solidification process, mechanical energy, such as in the form of oscillations, is applied to the MMC melt. The applied energy permits the reinforcement bodies to nestle and pack more efficiently, thereby increasing their volumetric loading in the cast composite.

### CROSS-REFERENCE TO RELATED APPLICATIONS

This is a Continuation-in-Part of international patent application PCT/US06/35001, filed on Sep. 7, 2006 in the names of Jerry Weinstein et al., which international application claimed the benefit of U.S. Provisional Patent Application Ser. No. 60/715,101, filed on Sep. 7, 2005. The entire contents of each of these commonly owned patent applications is expressly incorporated by reference herein.

### BACKGROUND OF THE INVENTION

1. Field of the Invention

The instant invention pertains to metal matrix composite (MMC) bodies, and specifically, MMCs made by a modified casting technique. The instant invention furthermore exhibits some exemplary shaped articles made from such cast MMCs.

2. Discussion of Related Art

Metal matrix composites are a relatively new class of materials generally possessing one or more physical properties, or specific combinations of properties, that may be unobtainable in monolithic materials. A composite material typically consists of at least one matrix material that is continuous or interconnected throughout the body, and one or more reinforcement materials dispersed or distributed throughout the matrix material(s). The reinforcement component of the composite material may be in the form of discrete bodies, or may be slightly contiguous with one another. As the name suggests, a metal matrix composite (sometimes referred to in shorthand notation as MMC”) features one or more metals as the matrix component. The reinforcement component for a MMC is often a ceramic material, particularly a hard ceramic material such as silicon carbide, SiC, but is not limited in this way, and in general can be any substance that meets the definition of the reinforcement component and is compatible with the metallic matrix. Thus, the reinforcement component of a MMC body could be another metal. An example of such a MMC is tungsten particulate dispersed in a copper matrix.

One class or group of MMCs that has seen commercial application in recent years is that of silicon carbide particulate dispersed in an aluminum or aluminum alloy matrix, known in shorthand notation as “Al/SiC”. This class of MMCs can be produced by a variety of routes. One such approach is powder metallurgical in nature, whereby powders of Al and SiC are mixed, pressed, and sintered. Another approach involves forming a self-supporting porous body of the SiC particulate, often termed a “preform”, and causing the aluminum or alloy in a molten condition to infiltrate the preform. The molten metal can be pulled into the preform under a vacuum, it can be pushed in under applied pressure, which is sometimes termed “squeeze casting”, or it may wick in to the preform when a wetting condition between the molten metal and the preform material is created. With regard to the latter technique, the wetting condition is often created by coating the preform material with a wetting agent such as a metal like sodium, or a salt like cryolite or similar metal fluorides, or certain ceramics like magnesium nitride. See, for example, U.S. Pat. Nos. 4,056,874 and 4,828,008.

Al/SiC MMCs exhibit a number of property combinations that make them attractive materials for an increasing number of applications. In particular, they offer many of the desirable properties of unreinforced aluminum such as low density (lightweight) and high thermal conductivity but with much higher stiffness and much reduced thermal expansion coefficient, which is important in making precision components. Further, they offer much higher mechanical toughness than ceramics or most ceramic composites.

However, there is a need for many of the precision components to be of a large size, that is, having a mass greater than 20 kg and/or having one or more dimensions that is a significant fraction of a meter in length, possibly even more than a meter. There are a number of such components in the semiconductor fabrication equipment industry, for example, gantry beams and machine bases, that need to be this substantial in size. Unfortunately, most of the commercially available Al/SiC MMC fabrication techniques either cannot make, or are hard-pressed to make such large structures, at least in a single, unitary piece.

One potential solution to this problem has resulted in the recent development of cast ceramics such as cast alumina. However, alumina is not as light as Al/SiC MMC; further, it suffers from low fracture toughness.

Another potential solution to this problem was the development of MMCs in castable form. Perhaps the most well known castable MMC was developed and commercialized by Duralcan, a subsidiary of Alcan Aluminum Company. This castable aluminum-based MMC comes in silicon carbide or aluminum oxide varieties as reinforcement. These castable MMCs were made by a “stir casting” approach, whereby the ceramic particulate is stirred into a bath of molten aluminum metal in vacuum or inert atmosphere by means of an impeller that forces molten metal into intimate contact with the normally difficult-to-wet ceramic. Castable MMCs containing up to about 30 percent by volume of ceramic particulate are commercially available.

Other MMC fabrication techniques are also amendable to making castable MMC. In general, however, the MMCs made by the powder metallurgical or preform infiltration techniques will not readily flow, and thus are not readily castable, even when their matrix metals are heated to a condition in which they are completely molten. Typically, the reinforcement loading is too high for castability, and additional matrix metal must be added. Further, and with specific regard to MMCs made by infiltrating preforms, often there is at least a tenuous film, skeleton or skin layer holding the reinforcement bodies together, and this must be broken up before the MMC can be rendered castable. This is in addition to the normal requirement to add more matrix metal to dilute down the reinforcement loading. This comminution can be accomplished by means of a high-shear impeller. See, for example, U.S. Pat. No. 6,223,805, the contents of which are expressly incorporated herein by reference in their entirety.

The desired large components and structures can be made by the casting technique. However, it is difficult to produce MMCs in castable form where the reinforcement loading is greater than about 30 or 35 volume percent. Since at least two of the desired properties sought in the precision component market, namely high stiffness and low CTE, are controlled largely by the volumetric loading of reinforcement, this constraint on the loading for castability reasons limits the property improvement that can be achieved. What is need is a castable MMC that is not limited in this way, and specifically, a castable MMC that has a higher loading of the reinforcement component. The instant invention provides a solution.

### OBJECTS OF THE INVENTION

Thus, in view of the present state of materials development, it is an object of the instant invention to develop a material and/or process that is conducive to the production of large, unitary structures.

It is an object of the instant invention to utilize a casting, or casting-like technique for shape fabrication.

It is an object of the instant invention to avoid having to infiltrate a shaped porous body (e.g., a “preform”) to make shaped MMC bodies.

It is an object of the instant invention to produce a MMC body of relatively high loading of the reinforcement component.

It is an object of the instant invention to produce a material that is light, stiff and tough.

It is an object of the instant invention to produce a metal composite material that is relatively easy to machine, at least in comparison to ceramics and most other MMCs.

It is an object of the instant invention to produce a metal composite material that is amenable to being drilled and tapped.

### SUMMARY OF THE INVENTION

These and other objects of the present invention are achieved with metal matrix composite materials (MMCs), and particularly with cast or castable MMCs. Specifically, and according to the instant invention, a castable MMC is heated to at least the melting point of its matrix metal to render it castable. The “molten” MMC is then cast into a mold, preferably one of desired shape. Provided that the reinforcement bodies are not so small (e.g., colloidal-sized) that they are suspended indefinitely by Brownian motion, virtually all known castable MMC materials at this point will begin to stratify. That is, the reinforcement component, being of a different density than that of the matrix metal, begins to settle out of suspension to form a sediment, that is, a zone of increased volumetric loading relative to the homogeneous condition. Typically, the reinforcement component has a greater theoretical density than does the matrix metal, so the reinforcement settling occurs at the bottom of the mold, and not at the top of the melt. (The terms “above”, “bottom”, “down”, “top” and “up” are construed herein to refer to directions with respect to the direction of gravitational force.) Concurrently, a zone that is highly loaded in matrix metal and sparsely loaded, or even denuded, of the reinforcement component, forms adjacent (usually above) the sedimented zone. The zone of sparsely loaded MMC may, at this point, be decanted, leaving the reinforcement-enriched zone behind, which is then solidified and de-molded. Alternatively, the stratified MMC casting may be solidified, and then the sparsely loaded zone is removed from the reinforcement-enriched zone, e.g., by sawing, machining, eroding, corroding, etc.

Without wishing to be bound to any particular theory or explanation, it may be the case that when the matrix metal of the MMC contains two or more metals that melt incongruently, the reinforcement bodies may be shoved around during solidification, possibly by the growing crystallites of the primary phase. Thus, upon solidification, the reinforcement bodies are not as uniformly distributed and not packed as efficiently as they could be. Accordingly, and in a preferred embodiment of the instant invention, during the settling and/or the solidification process, mechanic energy, preferably in the form of vibration, is applied to the MMC melt. The applied energy permits the reinforcement bodies to nestle and pack more efficiently, thereby increasing their volumetric loading in the cast composite.

### BRIEF DESCRIPTION OF THE FIGURES

FIGS. 1A and 1B are low and high magnification optical photomicrographs of polished cross-sections of a typical cast Al/SiC MMC having a SiC volumetric loading of about 30 percent;

FIG. 2 shows a cross-section of a component cast into a hot mold with Duralcan F3S.30S Al/SiC ingot;

FIGS. 3A and 3B are photomicrographs of the denuded and SiC-rich zones of the cast component of FIG. 2, respectively;

FIG. 4 shows a microstructure of a cast Al/SiC MMC material of a preferred vibratory embodiment of the instant invention;

FIG. 5 is a schematic diagram illustrating the major steps in carrying out the instant “sedimented MMC” invention;

FIG. 6 is a photograph of a furnace with crucible and 7 molds;

FIG. 7 is a photograph of a furnace at temperature during a sedimentation test;

FIG. 8 is a photograph of machined sedimentation samples, from left to right, as-cast, 0.5 hr., 1, 3, 4, 5, and 6 hr. sedimentation time;

FIG. 9 is a photograph showing the interface between “de-nuded” zone and sediment layer;

FIG. 10 is a graph showing the average sediment loading versus time;

FIG. 11 is a photograph of a furnace set-up for the vibration embodiment of this instant sedimentation trial;

FIG. 12 is a graph of Hardness as a function of location within the casting, for both the “vibrated” and “settled only” embodiments of the instant invention;

FIG. 13 is a chart of Hardness as a function of settling time, for both the non-vibrated and vibrated embodiments of the instant invention;

FIG. 14 is a graph of Hardness and elastic modulus as a function of location within a casting;

FIG. 15 is an approximately 400× optical photomicrograph of a polished cross-section of the Al/SiC MMC casting made according to Example III;

FIG. 16 is a photograph of a 330 mm×330 mm high stiffness, ribbed plate cast from Al/SiC using the “settled only” embodiment (no vibration);

FIG. 17 is a close-up photograph of a portion of the ribbed plate of FIG. 16; and

FIG. 18 is a photograph of a cast 620 mm×460 mm high stiffness, machine base in the final stages of machining.

### DETAILED DESCRIPTION OF THE INVENTION

Castable MMCs are the platform, or route, by which large complex structures of a composite material may readily be fabricated. Once the overall shape has been cast, the casting of MMC material is further processed to increase the volumetric loading of the reinforcement component of the MMC, thereby enhancing the desirable properties of the reinforcement component, such as high stiffness and/or low CTE.

Specifically, and to carry out the inventive technique of a preferred embodiment of the instant invention, a castable MMC composition is provided, and the matrix metal of the MMC is melted. In the alternative, an otherwise non-castable MMC may be provided, and subsequently rendered castable, for example, by providing additional matrix metal to the molten matrix. Comminution may also be needed if the reinforcement is highly loaded, and/or if reinforcement particles are, networked or otherwise bonded to one another. See, for example, U.S. Pat. No. 6,223,805 mentioned previously. Although the reinforcement component typically is still solid, for convenience, a MMC in this condition may be referred to in this disclosure as a “MMC melt” or “molten MMC”. The molten MMC is then cast into a mold, preferably one of desired shape. Any stirring or agitation that one might normally perform to help disperse the reinforcement bodies is then halted.

Left unmixed, at this point, virtually all known castable MMC materials will begin to stratify, that is, the reinforcement component, being of a different density (almost always greater) than that of the matrix metal, begins to settle out of suspension to form a sediment, that is, a zone of increased volumetric loading relative to the homogeneous condition. Concurrently, a zone that is highly loaded in matrix metal and sparsely loaded, or even denuded, of the reinforcement component, forms adjacent (usually above) the sedimented zone. The zone of sparsely loaded MMC may at this point be decanted, leaving the reinforcement-enriched sedimented zone behind, which is then solidified and de-molded. Alternatively, the stratified MMC casting may be solidified, and then the sparsely loaded zone is removed from the reinforcement-enriched zone, e.g., by sawing, machining, eroding, corroding, etc. The sedimented zone typically features a homogeneous and uniform distribution of the reinforcement material.

A typical microstructure of such a material is shown in FIGS. 1A and 1B. This material is a cast Al/SiC MMC, with silicon carbide ceramic particulate distributed throughout a matrix containing predominantly aluminum metal. The distribution is more-or-less homogeneous, at least on a macroscopic scale. Al/SiC MMCs, particularly castable MMCs, generally also contain some silicon metal as an auxiliary or alloying constituent of the metal component of the MMC. Here, the silicon can be seen as the gray phase 11 in the photomicrograph. The lightest phase 13 seen in the photomicrograph is aluminum, or an aluminum-rich metal solution. The darkest phase 15 is silicon carbide particulate. The largest regions of this light phase is termed “primary” aluminum, meaning that during cooling form the molten condition, it is the first phase to solidify. In a simple two-component alloy phase diagram, such as the aluminum-silicon system, there are only two phases to solidify: an aluminum-containing silicon phase, and a silicon-containing aluminum phase. Thus, in this photomicrograph, this last portion of the melt to solidify, indicated by the regions that seem to contain a large number of stripes or short parallel lines, is termed the “eutectic composition”. This is the composition that has the lowest melting point, and it freezes congruently, meaning that it freezes at a single temperature, and not over a range of temperatures. Upon solidifying, however, this eutectic composition separates into the silicon and aluminum-rich phases, respectively.

Although cast MMC suppliers are fond of saying that their product is uniform and homogeneous, even a casual inspection of the microstructure of the cast MMC of FIG. 1B reveals at least a certain amount of “clumping” or “clustering” of the SiC particles, and that their distribution throughout the matrix metal could stand improvement over what is shown. Without wishing to be bound to any particular theory or explanation, Applicant believes that the organization of the SiC particles into clumps or clusters results during matrix metal solidification, and specifically that nucleation and growth of primary phase metal crystals push the SiC particles out of the way of a developing matrix metal particle. This would help explain why the SiC particles are located predominantly in regions containing eutectic composition material.

At the same time, Applicant is aware of other analogous evidence, such as the settling behavior of ceramic particulates in aqueous-based fluids that suggests that, in the absence of mechanical action such as vibration to “nest” the particles, the particles do not pack as efficiently as they could. Thus, it may be the case that particles settling out of a MMC melt may pack inefficiently in the absence of vibration, even if the solidification of the metal is congruent and there is no “particle pushing” by the solidification of a primary matrix metal phase.

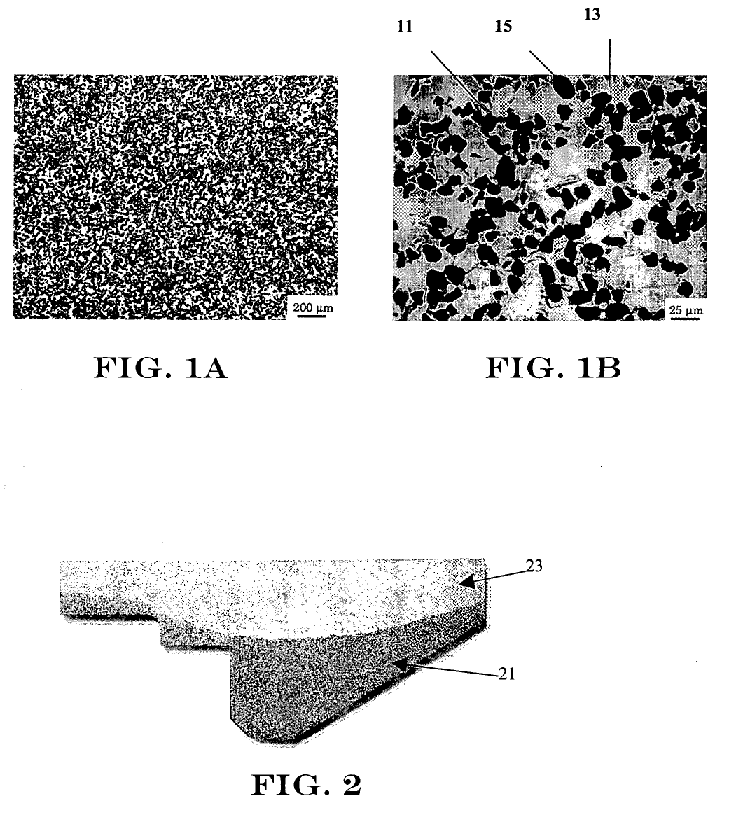

FIG. 2 shows a photograph of a cross-section of a cast Al/SiC MMC material (Duralcan F3S.30S) of the instant invention. Here, the overall composition is not homogeneous across the extent of the casting, but rather, the casting has been allowed to rest in a molten condition, thereby permitting the SiC reinforcement to settle out of suspension in aluminum alloy matrix metal. The settled, sedimented, or SiC-rich zone 21 thus lies beneath an alloy-rich zone 23 that has been largely denuded of SiC reinforcement.

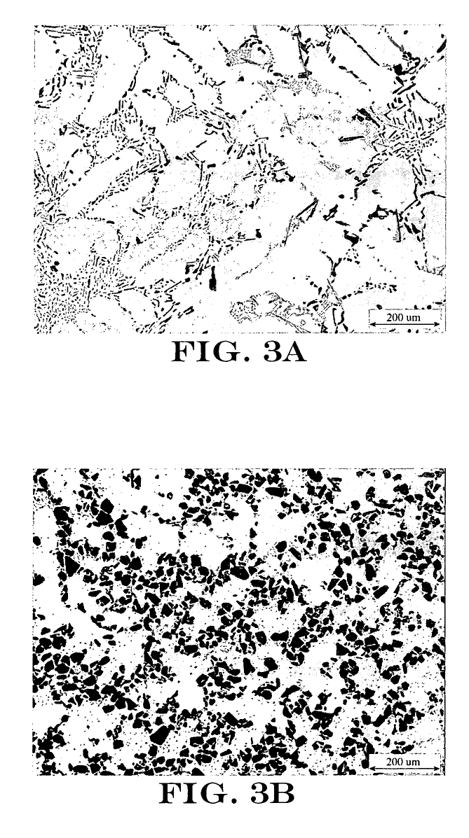

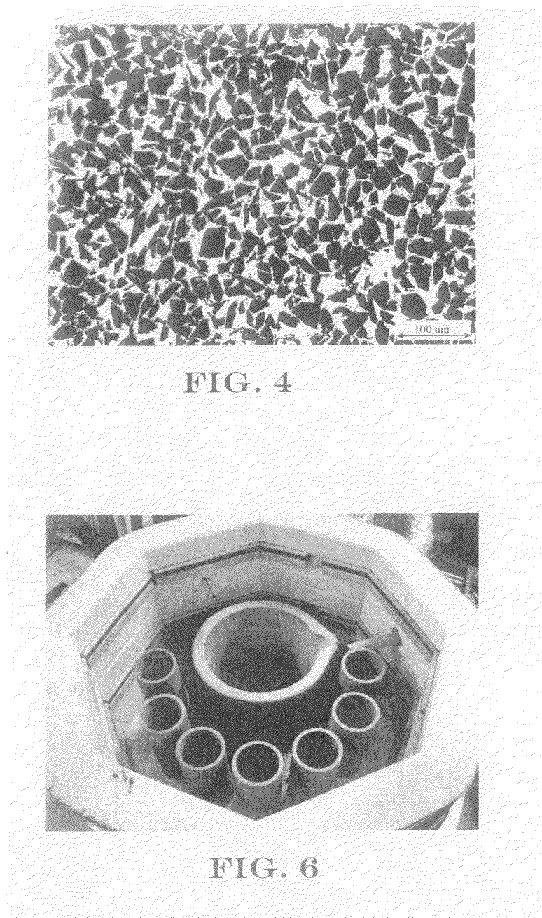

FIGS. 3A and 3B are photomicrographs of the denuded and SiC-rich zones of the cast component of FIG. 2, respectively. The settling is complete and clean. The alloy layer contains no SiC particles (FIG. 3A). The settled layer (FIG. 3B) appears to have about the same degree of uniformity as the non-settled MMC of FIG. 1B, except that the SiC loading is somewhat higher. Quantitative image analysis (QIA) reports that the SiC loading in this settled zone is about 45 percent by volume. Nevertheless, there is still clumping or clustering of SiC particles. Thus, particle packing could be higher still.

FIG. 4 shows a microstructure of a cast Al/SiC MMC material of one embodiment of the instant invention. The volumetric loading of SiC is clearly greater than that of FIGS. 1B or 3B even though the SiC particles are of substantially the same size and have substantially the same particle size distribution in all three photomicrographs. Further, obvious clumping or clustering of the SiC particles cannot be seen, at least not by routine visual inspection. Nevertheless, the MMC material represented by this microstructure was made by a casting process.

Specifically, and to carry out the inventive technique of a preferred embodiment of the instant invention, a castable MMC composition is provided, the matrix metal of the MMC is melted, the MMC is cast, and the melt is permitted to stratify, specifically by way of the settling of the reinforcement bodies. Before the matrix metal is cooled to solidify it to a solid condition, mechanical energy in the form of waves is imparted to the cast MMC melt. The energy may be applied after some or all of the settling process is substantially completed, or it may be applied during substantially all of the settling process. The energy may also be applied as the matrix metal is solidified.

The mechanical wave energy may be vibratory in nature. Further, the precise waveform should not be critical, and waveforms such as sine, sawtooth and square waves should work satisfactorily. Still further, the wave may be a pressure wave, a shear wave, or some combination. Applicant realizes that shear waves cannot be propagated any great distance in a liquid, however, they may have some effect in the instant MMC melts, since the melts can be considerably loaded in solid particles. Frequencies between about 5 Hertz and 5000 Hertz should be satisfactory, with frequencies between about 20 Hz and 200 Hz being preferred. Thus, at least some of the energy can be in the acoustic range of frequencies. The mechanical energy waves may be applied in a continuous fashion, or may be applied in pulses or bursts. A series of low-force impacts, shocks or jolts might also achieve the desired results.

It appears that the amplitude of the mechanical energy waves only needs to be sufficient to slightly move a reinforcement body with respect to adjacent bodies. Gravity then will permit the bodies to nestle and to pack tightly together. The amplitude of the mechanical energy waves should not be too high, or cavitation might result, which would be indicated by the presence of pores in the solidified MMC body. Alternatively, an excessively high degree of vibration will not result in reinforcement bodies forming tightly packed arrangements, but instead will cause them to more evenly disperse throughout the melt. Vibration was stated as being suitable for this purpose in U.S. Pat. No. 5,222,542.

Without wishing to be bound to any particular theory or explanation, it may also or alternatively be the case that the mechanical energy imparted during solidification is sufficient to overcome the surface energy-driven tendency for developing primary phase crystals to push the reinforcement bodies out of their way. Or it may be that the mechanical energy creates more sites for nucleation and growth of the primary crystallites, thus leading to a larger number but of smaller primary crystals before eutectic solidification. If this were to occur, the reinforcement bodies would not be pushed around as much before the onset of solidification of the eutectic phase.

Most any technique for making MMCs or castable MMC should work in conjunction with the instant invention. For example, squeeze casting or pressure casting techniques, such as that described in U.S. Pat. No. 5,511,603, COMPOCASTING™ techniques such as that described in U.S. Pat. No. 3,948,650, stir casting techniques such as that described in U.S. Pat. No. 4,786,467, pressureless metal infiltration techniques such as that described in U.S. Pat. Nos. 4,828,008 and 5,222,542, and powder metallurgical techniques such as that described in U.S. Pat. No. 4,354,964 should each function in connection with the instant settling process. The entire disclosures of each of these patents is expressly incorporated herein by reference.

With respect to the aluminum-silicon matrix metal system, an aluminum alloy system that is very commonly used in making Al/SiC MMCs, the instant invention should be operative regardless of whether the system is hypoeutectic or hypereutectic. Applicant appreciates, however, that in the hypereutectic system, the primary phase will be silicon metal and not aluminum metal. (Although physicists sometimes classify elemental silicon as a semimetal or “metalloid”, for purposes of this invention it will be considered to be a metal.)

The instant invention should also be operative in castable MMCs having other alloy systems for the matrix metal, particularly where particle pushing occurs. The instant invention should be operative in castable MMC systems where the matrix metal consists of two or more constituents and the constituents do not solidify at the same time. It may also be the case that the instant invention may provide benefits in terms of higher reinforcement particle packing efficiency and more refined microstructure even in one-component matrix metal systems, that is, matrix metal systems where the solidification is congruent. Other matrix metal systems that should be operative in connection with the instant invention include the well known castable metals such as magnesium, titanium, copper, tin, zinc, iron, nickel and their alloys. Silicon alloys are not common casting alloys, but they may also function according to the instant invention.

Applicant is not aware of a commercially produced castable MMC whose reinforcement bodies are more than a millimeter or so in size. This may be because, in the castable condition, Stokes' Law is in effect, and the larger the bodies, the faster they will settle out of suspension. For most castable MMCs, this is a problem. Since the instant invention takes advantage of the settling phenomenon, this is not nearly as great an issue, and it may be possible to employ even larger reinforcement bodies in the castable MMCs of the instant invention. As suggested previously, the lower limit of reinforcement size likely will be controlled by the fact that sufficiently small bodies will never settle out of suspension in a fluid, regardless of how dense they are, if the Brownian motion of the molecules of the fluid is sufficiently vigorous to keep them suspended. In the Al/SiC MMC system, this should not occur until the reinforcement bodies are reduced in size to the submicron size range. Note, however, that the product literature for Duralcan Grade F3S.30S castable Al/SiC (Alcan Inc., Jonquière, Québec, Canada) indicates that SiC particles as large as 3 microns in size will not settle out.

Up to now, the invention has considered mono-sized reinforcement bodies. With care, castable MMCs having a range or distribution of sizes should also be functional in the instant invention. Here, because of the operation of Stokes' Law, the potential problem will be the segregation of the reinforcement bodies according to size (assuming constant density). If a gradient structure is desired, this may not be a problem, but this discussion will assume that one desires for the final article-of-commerce product as uniform a composition as possible. As mentioned above, larger bodies will tend to settle out faster than smaller ones. However, if the range of sizes is not too wide, the amount of segregation by size during the settling process can be kept to a minimum:

Most of the commercially available castable MMCs feature particles for the reinforcement bodies. However, MMCs have been produced with reinforcement bodies having different morphologies such as fibers and platelets. Accordingly, the instant invention should work with several different shapes for the reinforcement bodies, and not just particles or sphere. Specifically, reinforcement morphologies such as flakes, platelets and whiskers or other short fibers such as chopped fibers should also function effectively in the instant invention. MMCs having long fibers can also be rendered castable if the reinforcement fibers can be wadded or coiled up in the form of pills. See, for example, Japanese Patent No. JP63192830, whose contents are expressly incorporated herein by reference.

As will be seen in the discussion of the examples to follow, the settling and vibration techniques are quite effective in raising the volumetric loading of reinforcement in cast MMCs. Specifically, a castable Al/SiC MMC that contains about 30 vol % SiC particulate having a fairly narrow particle size distribution can be increased to about 37-45 vol % just by letting the SiC particles settle out of suspension in the molten aluminum alloy. Adding vibration during the settling and/or freezing steps increases the loading of the sediment further, up to about 50-60 vOl %. By broadening the particle size distribution somewhat, reinforcement loadings of 60-70 vol % should be possible. This can be accomplished, for example, by mixing 240 and 500 mesh particulate (average particle sizes of about 66 and 17 microns, respectively) in about a 70:30 volume ratio.

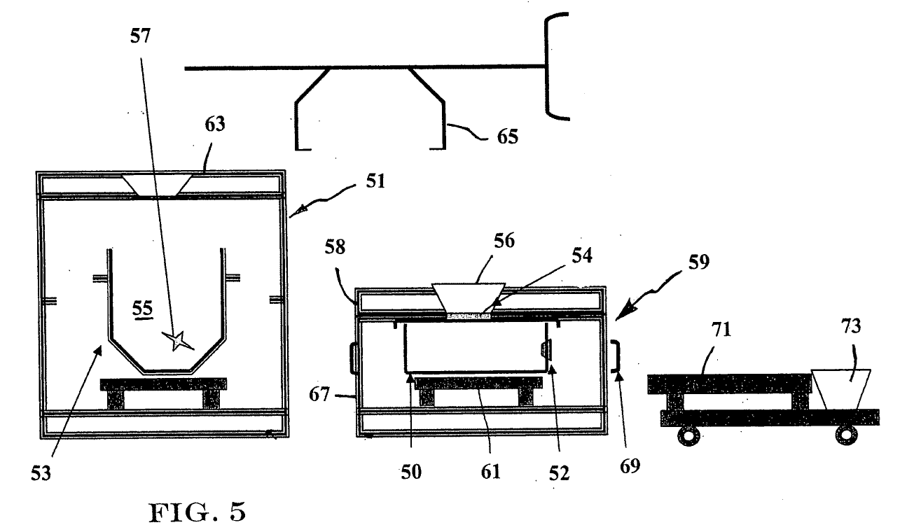

The following general description references FIG. 5, and describes a procedure for carrying out the method of the instant invention.

Two air-atmosphere furnaces (kilns) are provided. The kilns may be top-loading, and are capable of heating to a temperature of at least about 800° C. The first kiln 51 contains a graphite crucible 53, optionally coated with a mold wash such as boron nitride particulate to reduce oxidation. Into this graphite crucible is charged a quantity of metal matrix composite material 55 such as Al/SiC. The kiln is heated to at least the melting temperature of the MMC material, that is, to at least the melting point of the metallic matrix. Additional matrix metal is added if necessary to render the MMC castable. Just prior to casting, the castable Al/SiC MMC is stirred with mixing wand 57 to homogenize the material as much as possible.

The second kiln 59 contains the mold or chamber 50 of the desired shape to be cast. Again, this mold may be graphite coated with an appropriate mold wash. The mold also features a drain plug 52 located at a pre-determined height above the base of the casting mold. The MMC may be filtered using a traditional metal casting filter 54. However, the openings in the filter need to be of sufficient size to permit the reinforcement bodies of the castable MMC to pass through the filter. In FIG. 5, the filter is depicted as being part of, or integral, with the lid of the kiln. A funnel 56 is also integrated with the lid 58. The casting mold is supported on a pedestal or base 61. In the vibration embodiment, the entire kiln may be supported on a vibration unit (not shown). The second kiln is heated to an appropriate temperature for the casting operation. For Al/SiC, this temperature may be in the range of about 675° C.-800° C.

When the temperature of the two kilns has equilibrated at the desired temperatures, the lid 63 on the first kiln 51 is removed, and the crucible 53 containing the MMC melt 55 is lifted out of the first kiln, for example, by two persons manipulating the crucible with crucible casting tongs 65, and the Al/SiC MMC melt is carefully poured through the metal casting filter 54 in the lid 58 of the second kiln 59, and into the casting mold 50 contained in this second kiln. The cast Al/SiC MMC is then allowed to rest, during which time the SiC particulate settles out of suspension. The settling is substantially complete in about an hour. If vibration is employed, the vibration unit may be energized as soon as the cast MMC is poured, or even before the MMC is poured. If vibration is employed, settling may not be complete before about 4 hours of vibration have elapsed.

At this point, the casting features two well-defined zones. The bottom or lower zone features Al/SiC MMC material having a higher concentration of SiC particulate than the starting concentration in the homogenous cast MMC material. The top or upper zone features a lower concentration of SiC particulate than the starting cast MMC material, possibly even essentially zero SiC particulate.

After the settling is complete, the casting may be allowed to cool to solidify the matrix metal. In a different embodiment, however, the casting has its upper zone separated or removed from the lower zone by draining or decanting. Specifically, the sides 67 and lid 58 of the second kiln 59 may be removed, for example, by using the kiln lifting handles 69, and the mold 50 and its contents of molten MMC material is carefully transferred to a graphite chill plate 71 for solidification, which solidification may be directional for improved casting quality and refined microstructure. Before the matrix metal solidifies, however, the drain plug 52 is removed, and the melt of the upper zone drains into a crucible 73. The remaining lower zone is a metal matrix composite body that is highly loaded in SiC particulate and is a substantially homogeneous (i.e., not a gradient) structure.

Leaving the supernatant attached to the sedimented zone to yield a macrocomposite or gradient structure is generally satisfactory for smaller structures. When the size of the casting becomes appreciable, however, leaving the supernatant attached causes problems, at least in the aluminum/silicon carbide MMC system. Specifically, the difference in CTE is rather pronounced between aluminum and silicon carbide—about 23 and 4 ppm/K, respectively. Thus, there is a large CTE mismatch between the supernatant and the sedimented MMC zones. During solidification of the aluminum matrix metal, the CTE mismatch manifests itself as warping, cracking, etc. of the large casting, effectively destroying it.

The instant MMCs exhibit better machinability than do many other MMCs. Without wishing to be bound to any particular theory or explanation, this is believed to be due to the fact that the instant MMCs lack the skin or skeletal material (often a processing by-product) permeating the matrix metal. Again, this skeleton is often associated with MMCs made by infiltrating a preform, and could be, for example, a by-product of a binder used to cement the particles making up the preform to one another. In the PRIMEX pressureless metal infiltration process in particular, an aluminum nitride skeleton permeates the matrix metal as a by-product of this particular infiltration process. Although aluminum nitride is softer than many other ceramics, this aluminum nitride ceramic skeleton nevertheless makes machining of such infiltrated preforms more difficult than machining of the instant cast MMCs. The more difficult machining manifests itself, among other parameters, as shorter tool life.

Thus, what the instant technology provides is the ability to make large MMC structures that are highly loaded in the reinforcement component yet relatively easy to machine. This combination of features should not be underestimated. For two components that require machining, the larger one generally will require a greater volume of material removed by machining than the smaller one. In other words, the benefits provided by a material that is easier to machine than another material increase as the size of the component to be machined increases. The instant technology provides the ability to make large MMC structures that are highly loaded in the reinforcement component and lacking a skeleton or co-matrix. In other words, the metal component is the only matrix that is present in the MMCs of this disclosure.

The following examples illustrate with still more specificity several preferred embodiments of the present invention. These examples are meant to be illustrative in nature and should not be construed as limiting the scope of the invention.

### EXAMPLE I

This example demonstrates a modified casting technique applied to a commercially available castable MMC material to produce a MMC body of enhanced volumetric loading of reinforcement component.

Referring to FIG. 6, a large graphite crucible coated with mold wash was placed into a resistance-heated air atmosphere kiln (L & L Kilns, Boothwyn, Pa.) at ambient temperature. Seven smaller molds each measuring about 2 inches (about 5 cm) in diameter by about 8 inches (about 20 cm) in height were placed adjacent the large crucible. A quantity of castable Al/SiC MMC material (Duralcan Grade F3S.30S) being about 30 vol % loaded in SiC particulate and sufficient in quantity to fill the seven molds was placed into the large crucible. The furnace was then energized, and the castable MMC was then melted according to the manufacturer's directions.

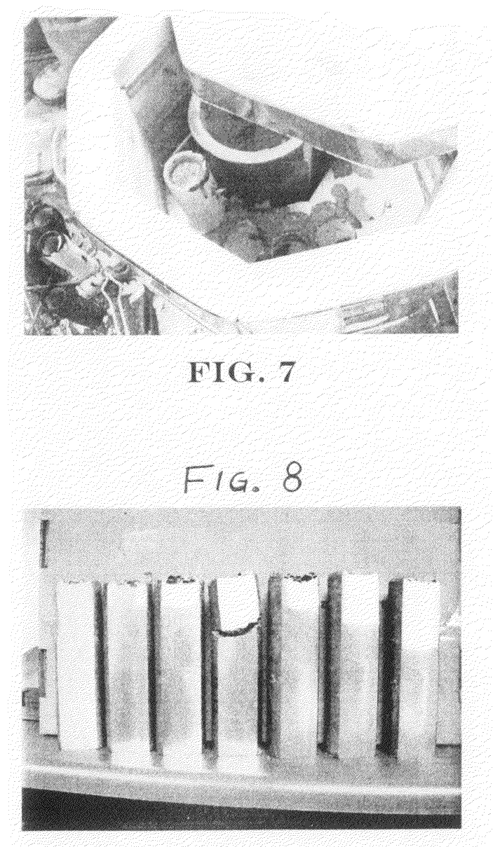

When the cast material had melted fully, the SiC particulate reinforcement was stirred or otherwise fully homogenized throughout the matrix metal. The MMC melt was then cast into the seven smaller molds in substantially equal amounts (see FIG. 7). A mold was pulled out of the furnace and its contents solidified under ambient conditions at the following approximate dwell times in the kiln: 0, 0.5, 1, 3, 4, 5 and 6 hours, respectively.

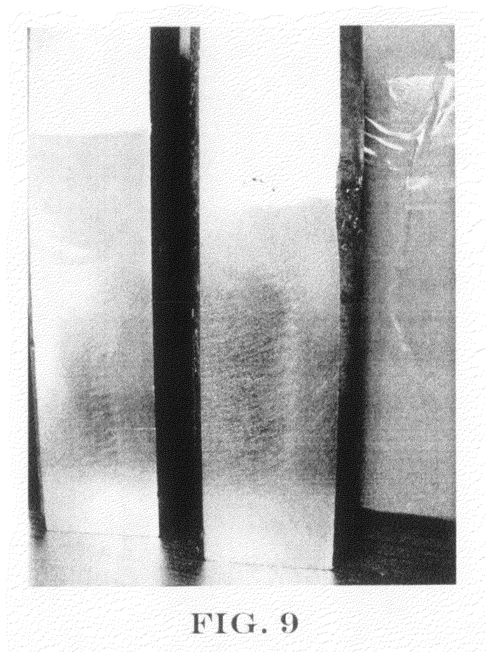

After each mold and its contents had cooled to substantially ambient temperature, the castings were recovered from the molds and sectioned longitudinally (see FIG. 8). The sectioned face was ground and polished as necessary to reveal the two different zones of each settled casting, as shown in FIG. 9. The lower zone is the sedimented zone, containing aluminum-silicon matrix metal and sedimented SiC particulate dispersed in the matrix metal. The upper zone contains substantially no SiC particulate—only matrix metal, and thus is referred to as the “denuded zone”. The total height of the casting as well as the height of the sedimented portion was then measured, whereby the settling or sedimentation rate and the SiC loading in the sedimented zone could be calculated.

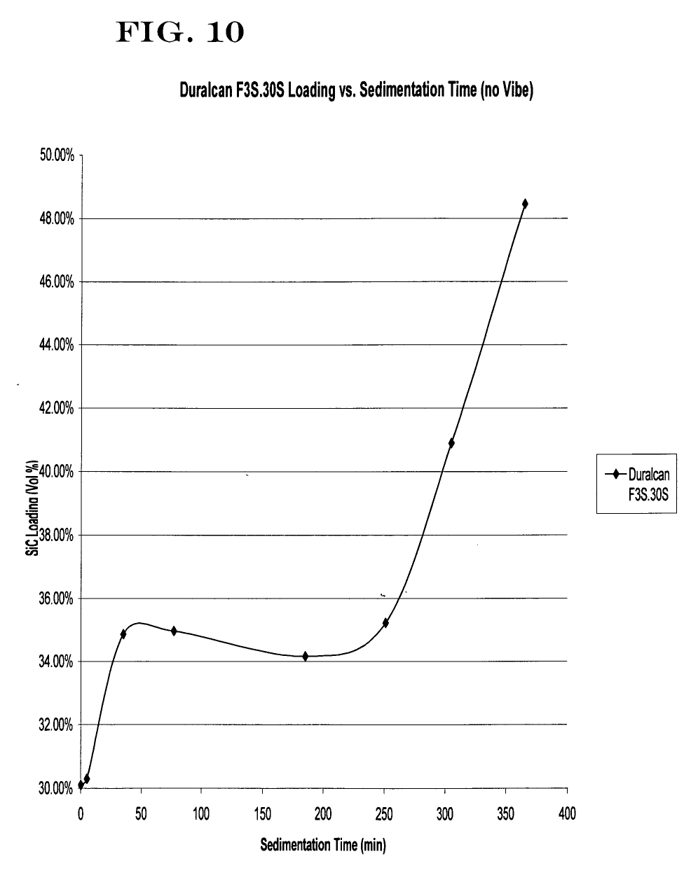

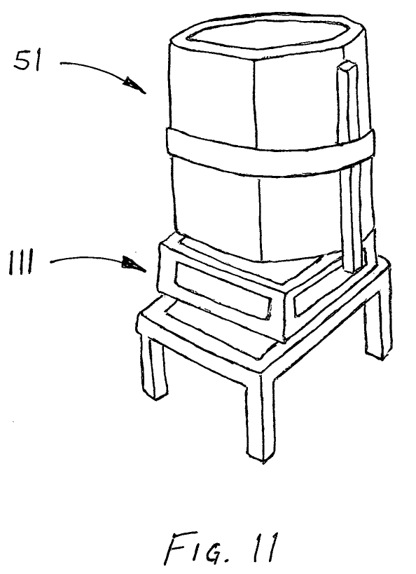

FIG. 10 shows the loading of SiC particulate in the sedimented zone as a function of settling time. Thus, this example shows that an initial 30 vol % SiC castable Al/SiC MMC yielded a SiC loading of about 48.5 vol % in the sedimented zone after casting and settling, and that it took about 6 hours to reach this degree of sedimentation.

### EXAMPLE II

This example demonstrates a modified MMC casting technique. Specifically, a castable MMC is cast and the reinforcement component is permitted to settle out of suspension. Vibration, is applied to the casting mold and its contents during at least a portion of the settling period. Thus, this, Example was conducted in substantially the same manner as was Example I, except for the vibration aspect.

Referring to FIG. 11, vibration was carried out during the settling period by prepositioning a SYNTRON™ vibration unit 111 (FMC Corporation, Philadelphia, Pa.) beneath the resistance-heated air atmosphere kiln 51. Vibration took place continuously throughout the settling period, with the vibration unit set to a “low” setting. Again, the objective is to impart just enough mechanical energy to the SiC particles in the melt to cause them to move slightly relative to their neighbors, thereby causing them to “nestle” among themselves, and/or to overcome the surface tension between the ceramic particles and the matrix metal. If the exact materials and components are not available, one skilled in the art nonetheless should be able to reproduce these results without undue experimentation. Specifically, it may be instructive to conduct some simple test runs on aqueous ceramic slurries at ambient temperature using different intensity settings of the vibration unit to get a feel for the approximate proper intensity setting to settle the similar reinforcement bodies to a high degree of loading.

### Characterization of Mechanical and Physical Properties

After the fabrication step, various mechanical and physical properties of the instant reaction-bonded ceramic composite materials were measured. Density was determined by measuring the bulk volume of a machined specimen, and dividing that into its mass. Elastic properties were measured by an ultrasonic pulse echo technique following ASTM Standard D 2845. Hardness was measured on the Rockwell B scale. Flexural strength in four-point bending was determined following MIL-STD-1942A. Fracture toughness was measured using a four-point-bend-chevron-notch technique and a screw-driven Sintech model CITS-2000 universal testing machine under displacement control at a crosshead speed of 1 mm/min. Specimens measuring 6×4.8×50 mm were tested with the loading direction parallel to the 6 mm dimension and with inner and outer loading spans of 20 and 40 mm, respectively. The chevron notch, cut with a 0.3 mm wide diamond blade, has an included angle of 60° and was located at the midlength of each specimen. The dimensions of the specimen were chosen to minimize analytical differences between two calculation methods according to the analyses of Munz et al. (D. G. Munz, J. L. Shannon, and R. T. Bubsey, “Fracture Toughness Calculation from Maximum Load in Four Point Bend Tests of Chevron Notch Specimens,” Int. J. Fracture, 16 R137-41 (1980))

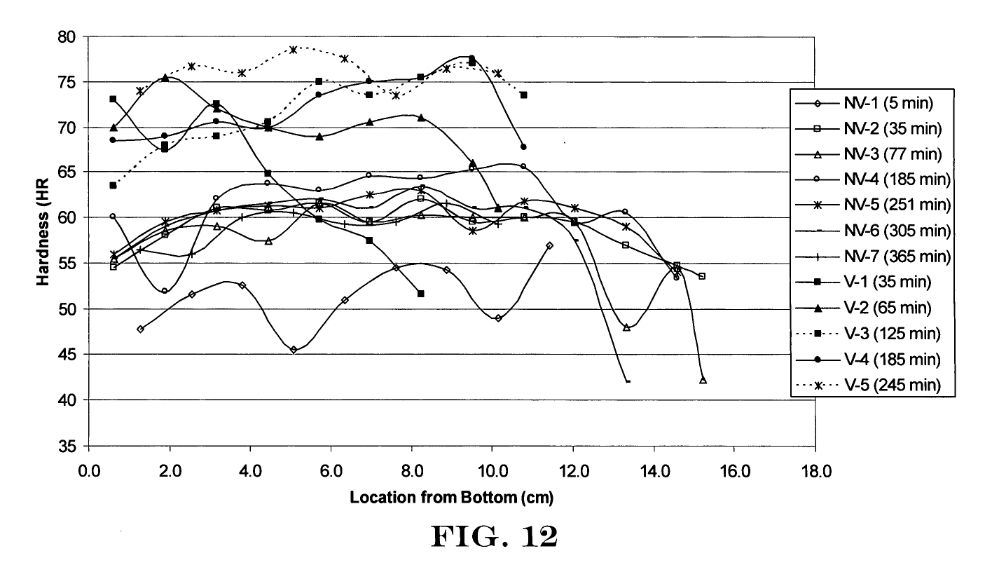

FIG. 12 shows Rockwell B Hardness as a function of distance from the bottom of the casting for each of the seven castings exposed to no vibration, and for five castings exposed to vibration during the settling periods. In the chart legend, “NV” refers to samples that were not vibrated, whereas samples with a “V” in their designation were vibrated. Among the conclusions that can be drawn are the following:

a loading of about 50 volume percent of SiC had been achieved after about 150 minutes of settling and vibration

the vibrated material clearly has not finished settling in 35 or even after 65 minutes

the vibrated samples have higher hardness than non-vibrated samples

the lower levels pack first, and then upper levels

hardness drops off at the highest levels in the casting (greatest distance from the bottom).

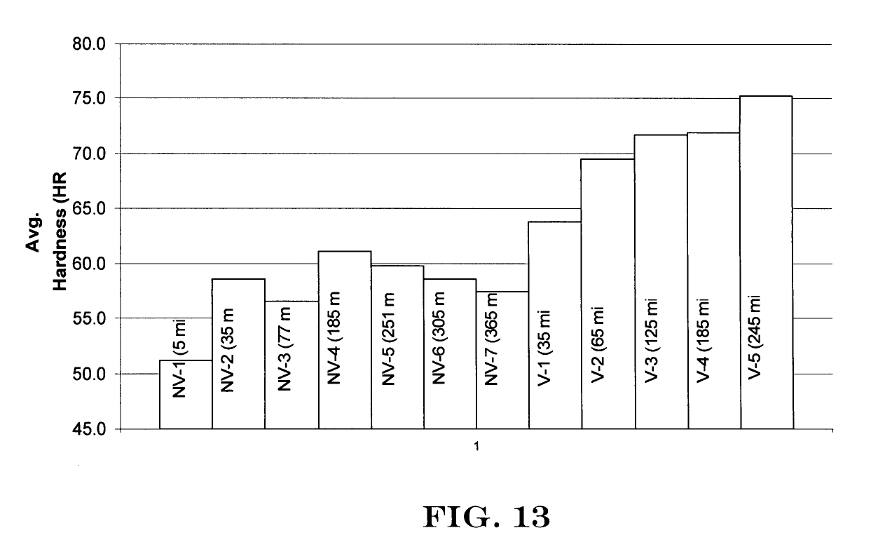

FIG. 13 shows Rockwell B hardness of the sedimented Al/SiC MMC castings as a function of settling time for the non-vibrated and vibrated samples, respectively. Again, the figure legend reports the settling time in minutes rather than in hours, as was described for the casting procedure. This chart suggests that samples that are not vibrated are finished settling in about an hour, whereas the vibrated samples are not—they continue to settle and pack at the four-hour mark.

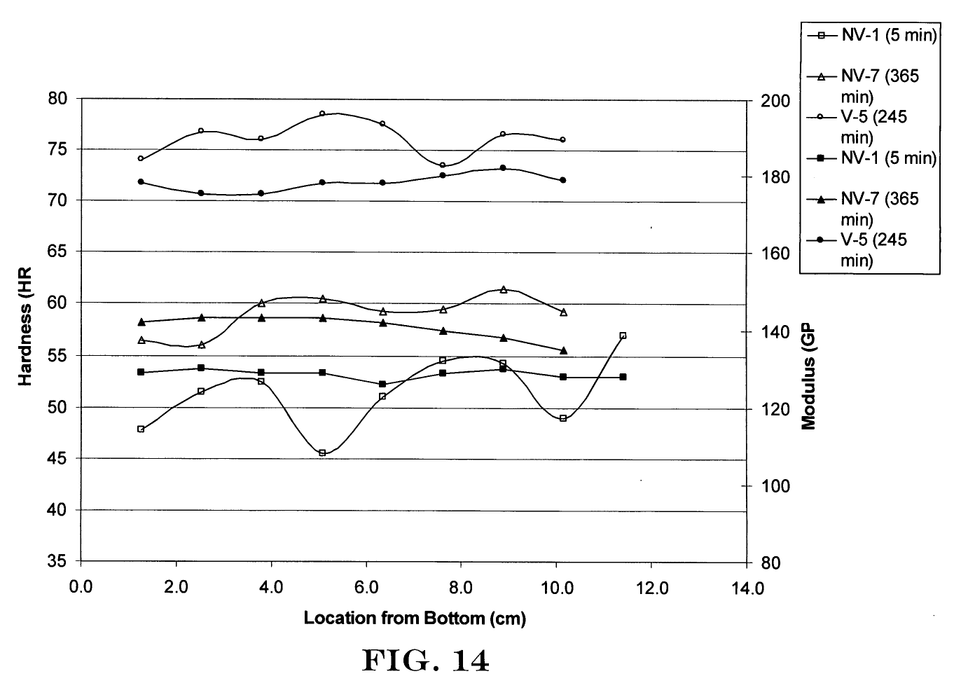

FIG. 14 shows both hardness and Young's modulus data for three castings: two in the non-vibrated condition, the other vibrated. The open data points refer to hardness measurements; the solid or closed data points indicate modulus. The modulus data show more uniformity in the samples than the hardness data imply. The modulus of the starting material, at 30% SiC is about 129 GPa, the “no vibe” material is about 141 GPa (loading of about 37%) and the “with vibe” sample is about 178 GPa (loading of about 50%).

The sample that was sedimented and vibrated for about 245 minutes (about 6 hours), Sample V-5, was then further characterized.

Al-50% SiC (Sample V-5)

| | |
|---|---|
| Density (g/cc) | 2.94-2.96 |
| Modulus (GPa) | 178 |
| Poisson's Ratio | 0.26 |
| Flex Strength (MPa) | 287 (6 flex bars) |
| Mean: | 286.9 |
| Min | 268.8 |
| Max | 324.5 |
| Stdv | 25.5 |
| Fracture Toughness (K_{1C}, MPa · m^{1/2}) | 13.4 (6 bars) |
| Mean: | 13.43 |
| Min | 12.98 |
| Max | 14.10 |
| Stdv | 0.39 |
| CTE (x10⁻⁶K⁻¹) | 10-12 |
| Thermal conductivity (W/m-K) | 160-200 |

Thus, the “settled with vibration” condition provides for a material with a high elastic modulus and good strength and toughness.

### EXAMPLE III

The cast MMC fabrication technique of Example II was substantially repeated, except the starting castable Al/SiC MMC material featured a bimodal distribution of SiC particulate, with about 30 percent of the particulate being the smaller size, and the balance being of the larger size. Specifically, the peaks of the particle size distribution were centered around 240 mesh and 500 mesh particulate, about 66 microns and 17 microns, respectively.

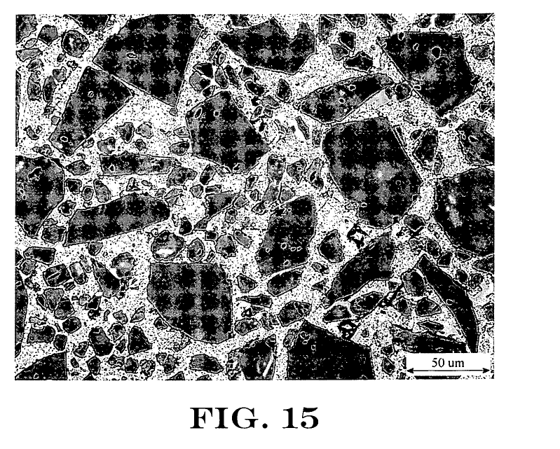

An optical photomicrograph of a polished cross-section of the resulting casting following vibration, sedimentation and solidification is shown in FIG. 15 at about 400× magnification.

### EXAMPLE IV

This Example demonstrates some commercially useful articles that may be fabricated using the techniques of the instant invention as described above. Each of these components was produced using Duralcan F3S.30S castable Al/SiC MMC containing about 30 percent by volume of SiC particulate as a starting material.

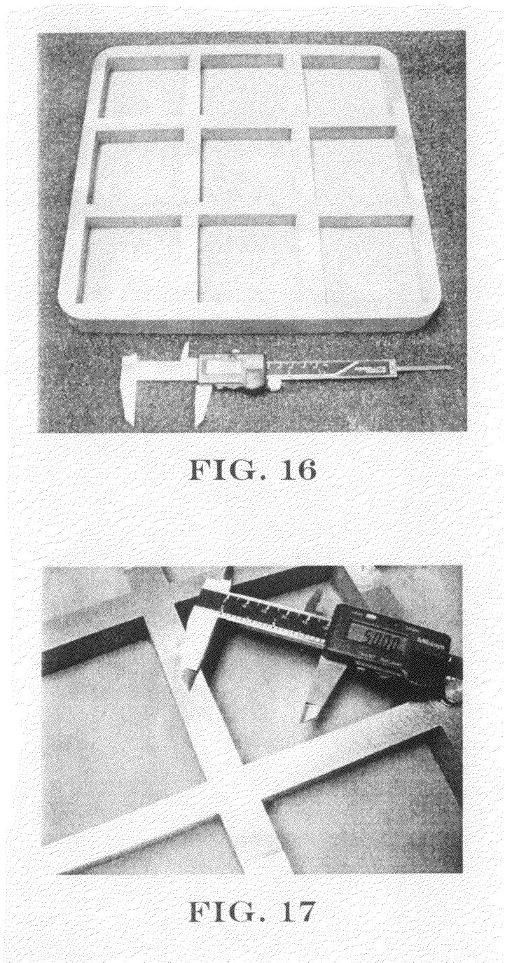

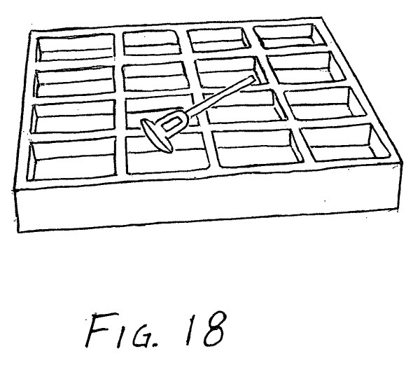

One such demonstration component was a 330 mm×330 mm high stiffness, ribbed plate, such as shown in FIGS. 16 and 17.

The mold into which the Al/SiC MMC was cast featured compressible cores to define the portions of the casting between the ribs. The settling featured a 4-hour isothermal hold at 700° C. in the no-vibration condition. At first, an attempt was made to pour the castable MMC material through a 20-openings per inch (about 8 openings per centimeter) casting filter, but the MMC did not feed through this filter properly. So, the casting run was repeated without a filter. The lack of filtering resulted in numerous “folds” visible on the as-cast surface of the test sample.

A second demonstration component featured a 620 mm×460 mm high stiffness, machine base cast using the vibration embodiment (see FIG. 18). In particular, this run featured a 4-hour isothermal hold at 700° C. with vibration to achieve high loading. Furthermore, it utilized an “alloy box” to reduce oxide skin entrapment in the part. After settling, the casting was removed from the furnace and vibration unit hot and solidified on a chill plate.

### INDUSTRIAL APPLICABILITY

The methods and compositions of the present invention find utility in applications requiring complex shapes, sometimes being large unitary complex structures, machining at an intermediate stage of development, high dimensional accuracy and precision, high specific stiffness, low thermal expansion coefficient, high hardness, high toughness, high thermal conductivity and/or high wear resistance. Accordingly, the metal matrix composite materials of the present invention are of interest in the precision equipment, robotics, tooling, armor, automotive, electronic packaging and thermal management, and semiconductor fabrication industries, among others. Open structures such as plates, optionally containing reinforcing ribs, and measuring a meter or more on a side, and perhaps weighing a metric ton or more, should be manufacturable using the instant techniques. Specific articles of manufacture contemplated by the present invention include, but are not limited to, semiconductor wafer handling components such as wafer tables, vacuum chucks, electrostatic chucks, air bearing housings or support frames, electronic packages and substrates, machine tool bridges and bases, beams such as gantry beams, mirror substrates, mirror stages and flat panel display setters. The materials of the instant invention may also find utility as ballistic resistant articles, e.g., armor, or as friction materials, e.g., brake or clutch components.

An artisan of ordinary skill will appreciate that various modifications may be made to the invention herein described without departing from the scope or spirit of the invention as defined in the appended claims.

What is claimed is:

1. A method of making a metal matrix composite article, comprising:
(a) providing a metal matrix composite material comprising a plurality of separate reinforcement bodies contained with a metallic matrix, said metal matrix composite material being capable of being cast when the metal is in a molten condition;
(b) rendering said metal molten;
(c) permitting at least a portion of said reinforcement bodies to settle;
(d) solidifying at least said metallic matrix to a solid condition;
(e) prior to said metallic matrix solidifying to a completely solid condition, subjecting said castable metal matrix composite body to mechanical energy in the form of waves or rapid physical oscillations; and
(f) continuing said subjecting while solidifying at least said metallic matrix to a completely solid condition.

2. The method of claim 1, further comprising casting said molten metal matrix composite material into a mold that inversely replicates at least a portion of a desired article of commerce.

3. The method of claim 2, wherein said subjecting is started while said metallic matrix is in a completely molten condition.

4. The method of claim 1, wherein said settling results in a zone of said metal matrix composite that has a reduced loading of said reinforcement bodies relative to another zone, and further comprising separating said reduced loading zone from said another zone.

5. The method of claim 4, wherein said separating comprises, prior to said solidifying, draining said zone of reduced loading from said mold, thereby leaving said another zone in said mold.

6. The method of claim 2, wherein said subjecting is stopped before said metallic matrix is in a completely solidified condition.

7. A method of making a metal matrix composite article, comprising:
(a) providing a metal matrix composite material comprising a plurality of separate reinforcement bodies contained with a metallic matrix, said metal matrix composite material being capable of being cast when the metal is in a molten condition;
(b) rendering said metal molten;
(c) permitting at least a portion of said reinforcement bodies to settle to form a sedimented region and a supernatant region;
(d) draining said supernatant region to leave a substantially homogenous metal matrix composite casting;
(e) solidifying at least said metallic matrix of said metal matrix composite casting to a solid condition; and
(e) prior to said metallic matrix solidifying to a completely solid condition, subjecting said castable metal matrix composite material to mechanical energy in the form of waves or rapid physical oscillations;

8. A metal matrix composite body, comprising:
(a) a matrix comprising at least one metal;
(b) at least 37 percent by volume of a reinforcement component comprising a plurality of separate bodies dispersed in said matrix metal; and
(c) a cast microstructure; and
(d) having at least one of (i) a mass of at least about 10 kg and (ii) at least one dimension of at least about 330 mm.

9. The metal matrix composite body of claim 8, wherein said matrix metal comprises at least one metal selected from the group consisting of aluminum, copper, iron, magnesium, silicon, tin and zinc.

10. The metal matrix composite body of claim 8, wherein said reinforcement bodies have a morphology selected from the group consisting of particles, flakes, platelets, spheres and fibers.

11. The metal matrix composite body of claim 8, wherein said reinforcement bodies comprise at least one ceramic material.

12. The metal matrix composite body of claim 8, wherein said reinforcement bodies comprise at least one material selected from the group consisting of SiC, Si₃N₄, AlN, AL₂O₃ and B₄C.

13. The metal matrix composite body of claim 8, wherein said reinforcement bodies are substantially mono-sized.

14. The metal matrix composite body of claim 8, wherein said reinforcement bodies exhibit a range or distribution of sizes.

15. The metal matrix composite body of claim 8, wherein said matrix metal is a hypereutectic alloy.

16. The metal matrix composite body of claim 8, wherein said matrix metal is a hypoeutectic alloy.

17. The metal matrix composite body of claim 8, wherein said matrix metal comprises aluminum and silicon, and said reinforcement bodies comprise silicon carbide particulate.

18. The metal matrix composite body produced according to the method of claim 1, wherein said another zone has a volumetric loading of the reinforcement bodies in a range of about 37 percent to about 65 percent.

19. The metal matrix composite body of claim 18, and further wherein said body exhibits a microstructure indicative of being cast.

20. The metal matrix composite body of claim 19, wherein said microstructure indicative of being cast comprises a higher concentration of reinforcement bodies in zones wherein said metallic matrix is rich in eutectic composition than in zones wherein said metallic matrix is rich in primary phase.
